(19) United States
(12) Patent Application Publication
(10) Pub. No.: US 2012/0050491 A1
(43) Pub. Date: Mar. 1, 2012

(54) METHOD AND SYSTEM FOR ADJUSTING AUDIO BASED ON CAPTURED DEPTH INFORMATION

(76) Inventors: Nambi Seshadri, Irvine, CA (US); Jeyhan Karaoguz, Irvine, CA (US); Xuemin Chen, Rancho Santa Fe, CA (US); Chris Boross, Sunnyvale, CA (US)

(21) Appl. No.: 13/174,344

(22) Filed: Jun. 30, 2011

Related U.S. Application Data
(60) Provisional application No. 61/439,201, filed on Feb. 3, 2011.
(60) Provisional application No. 61/377,867, filed on Aug. 27, 2010.

(51) Int. Cl. H04N 13/02

(52) U.S. Cl. 348/47; 348/E13.074

(57) ABSTRACT

Two-dimensional image may be captured via one or more image sensors of a monoscopic camera and depth information may be captured via one or more depth sensors of the monoscopic camera. A video stream may be generated from the captured two-dimensional image data based on the captured depth information. Corresponding audio to accompany the generated video stream may be generated based on the captured depth information. The generated video stream may be a 3-D video stream. The generated corresponding audio may be adjusted based on the captured depth information. A location and/or movement of an object appearing in the captured two-dimensional image data may be determined based on the depth information and based on pixel data of the captured two-dimensional image data. Characteristics of the generated audio, such as volume, frequency, delay, and balance, may be adjusted based on the determined location and/or movement.

### CLAIM OF PRIORITY

This patent application makes reference to, claims priority to and claims benefit from U.S. Provisional Patent Application Ser. No. 61/439,201 filed on Feb. 3, 2011 and U.S. Provisional Patent Application Ser. No. 61/377,867 filed on Aug. 27, 2010.

Each of the above stated applications is hereby incorporated herein by reference in its entirety.

### INCORPORATION BY REFERENCE

This patent application also makes reference to:
U.S. patent application Ser. No. ______ (Attorney Docket No. 23471US03) filed on even date herewith;
U.S. patent application Ser. No. ______ (Attorney Docket No. 23468US02) filed on even date herewith;
U.S. patent application Ser. No. ______ (Attorney Docket No. 23469US02) filed on even date herewith;
U.S. patent application Ser. No. ______ (Attorney Docket No. 23457US02) filed on even date herewith;
U.S. patent application Ser. No. 13/077,912 filed on Mar. 31, 2011;
U.S. patent application Ser. No. 13/077,922 filed on Mar. 31, 2011;
U.S. patent application Ser. No. 13/077,886 filed on Mar. 31, 2011;
U.S. patent application Ser. No. 13/077,926 filed on Mar. 31, 2011;
U.S. patent application Ser. No. 13/077,893 filed on Mar. 31, 2011;
U.S. patent application Ser. No. 13/077,923 filed on Mar. 31, 2011;
U.S. patent application Ser. No. 13/077,868 filed on Mar. 31, 2011;
U.S. patent application Ser. No. 13/077880 filed on Mar. 31, 2011;
U.S. patent application Ser. No. 13/077,899 filed on Mar. 31, 2011;
U.S. Provisional Patent Application Ser. No. 61/439,301 filed on Feb. 3, 2011; and
U.S. patent application Ser. No. 13/077,930 filed on Mar. 31, 2011.

Each of the above stated applications is hereby incorporated herein by reference in its entirety.

### FIELD OF THE INVENTION

Certain embodiments of the invention relate to audio processing. More specifically, certain embodiments of the invention relate to a method and system for adjusting audio based on captured depth information.

### BACKGROUND OF THE INVENTION

Support and demand for video systems that support three-dimensional (3-D) video has increased rapidly in recent years. Both literally and physically, 3-D video provides a whole new way to watch video, in home and in theaters. However, 3-D video systems are still in their infancy in many ways and there is much room for improvement in terms of both cost and performance.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for adjusting audio based on captured depth information, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

FIG. 1 is a diagram that illustrates an exemplary monoscopic, or single-view, camera embodying aspects of the present invention, compared with a conventional stereoscopic camera.

FIG. 2 is a diagram illustrating an exemplary monoscopic camera, in accordance with an embodiment of the invention.

FIG. 3 illustrates processing of depth information and 2D image information to generate a 3-D image, in accordance with an embodiment of the invention.

FIG. 4 is a diagram illustrating adjustment of audio characteristics based on a location of a sound source in a scene, in accordance with an embodiment of the invention.

FIG. 5 is a diagram illustrating adjustment of audio characteristics based on a location of a sound source in a scene, in accordance with an embodiment of the invention.

FIG. 6 is a diagram illustrating adjustment of audio timing based on a location of a sound source in a scene, in accordance with an embodiment of the invention.

FIG. 7A is a diagram illustrating exemplary steps for generating corresponding audio for a video generated by a monoscopic camera that captures two-dimensional image data via one or more image sensors and captures depth information via a depth sensor, in accordance with an embodiment of the invention.

FIG. 7B is a flowchart illustrating exemplary steps for adjusting audio associated with 3-D video based on distances and/or movement detected utilizing captured pixel data and/or captured depth data, in accordance with an embodiment of the invention.

### DETAILED DESCRIPTION OF THE INVENTION

Certain embodiments of the invention may be found in a method and system for adjusting based on captured depth information. In various embodiments of the invention, a two-dimensional image may be captured via one or more image sensors of a monoscopic camera and depth information may be captured via one or more depth sensors of the monoscopic camera. The depth sensor may utilize infrared waves transmitted by an infrared emitter of the camera. A video stream may be generated from the captured two-dimensional image data based on the captured depth information. The generated video stream may be a 3-D video stream. Corresponding audio to accompany the generated video stream may be generated based on the captured depth information. The generated corresponding audio may be adjusted based on the captured depth information. A location and/or movement of an object appearing in the captured two-dimensional image data may be determined based on the depth information and based on pixel data of the captured two-dimensional image data. Characteristics of the generated audio, such as volume, frequency, delay, and balance, may be adjusted based on the determined location and/or movement. As utilized herein a “3-D image” refers a stereoscopic image, and “3-D video” refers to stereoscopic video.

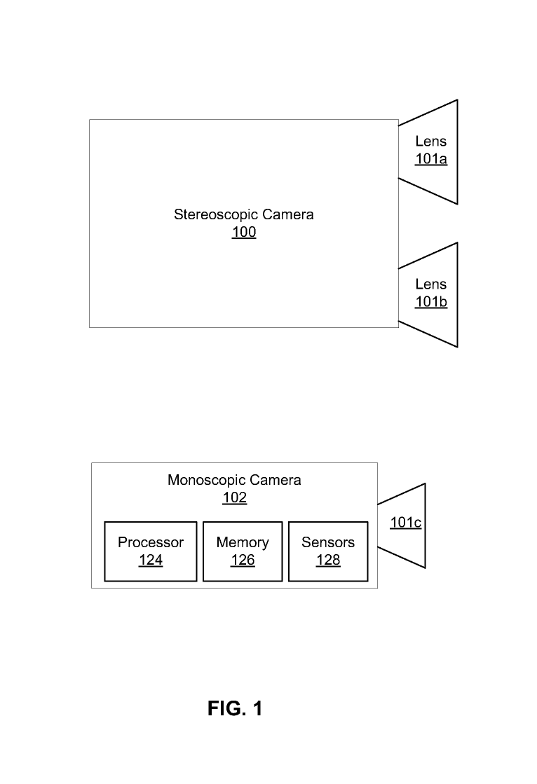

FIG. 1 compares a monoscopic camera embodying aspects of the present invention with a conventional stereoscopic camera. Referring to FIG. 1, the stereoscopic camera 100 may comprise two lenses 101a and 101b. Each of the lenses 101a and 101b may capture images from a different viewpoint and images captured via the two lenses 101a and 101b may be combined to generate a 3-D image. In this regard, electromagnetic (EM) waves in the visible spectrum may be focused on a first one or more image sensors by the lens 101a (and associated optics) and EM waves in the visible spectrum may be focused on a second one or more image sensors by the lens (and associated optics) 101b.

The monoscopic camera 102 may capture images via a single viewpoint corresponding to the lens 101c. In this regard, EM waves in the visible spectrum may be focused on one or more image sensors by the lens 101c. The image sensor(s) may capture brightness and/or color information. The captured brightness and/or color information may be represented in any suitable color space such as YCrCb color space or RGB color space. The monoscopic camera 102 may also capture depth information via the lens 101c (and associated optics). For example, the monoscopic cameral 102 may comprise an infrared emitter, an infrared sensor, and associated circuitry operable to determine the distance to objects based on reflected infrared waves. Additional details of the monoscopic camera 102 are described below.

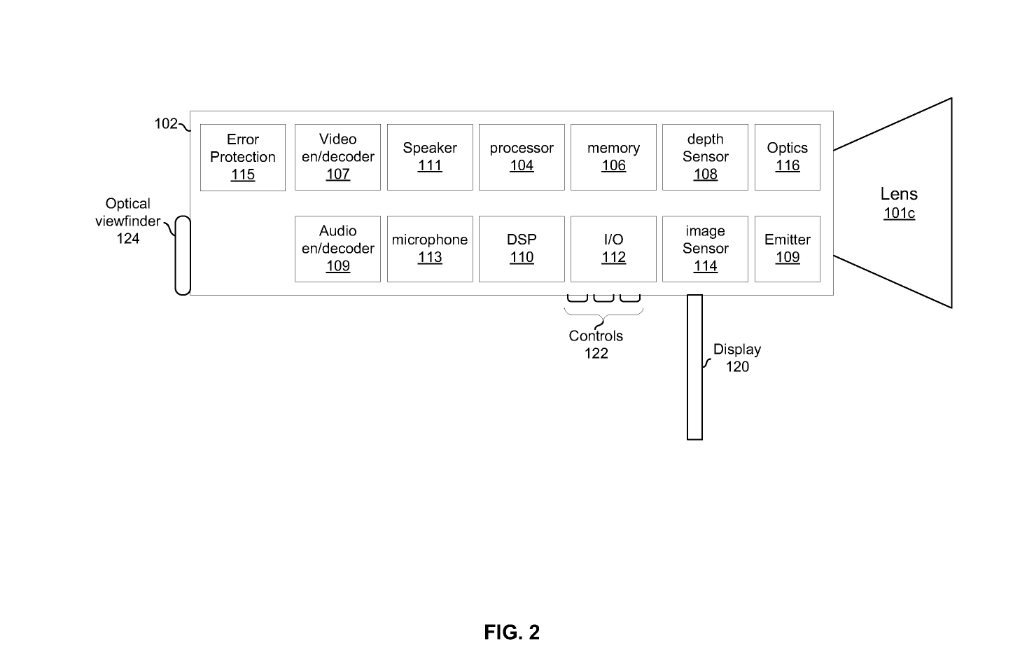

The monoscopic camera 102 may comprise a processor 124, a memory 126, and one or more sensors 128. The processor 124 may comprise suitable logic, circuitry, interfaces, and/or code that may be operable to manage operation of various components of the monoscopic camera 102 and perform various computing and processing tasks. A single processor 124 is utilized only for illustration but the invention is not so limited. In an exemplary embodiment of the invention, various portions of the monoscopic camera 102 depicted in FIG. 2 below may correspond to the processor 124. The memory 106 may comprise, for example, DRAM, SRAM, flash memory, a hard drive or other magnetic storage, or any other suitable memory devices. The sensors 128 may comprise one or more image sensors, one or more depth sensors, and one or more microphones. Exemplary sensors are described below with respect to FIG. 2.

FIG. 2 is a diagram illustrating an exemplary monoscopic camera, in accordance with an embodiment of the invention. Referring to FIG. 2, the monoscopic camera 102 may comprise a processor 104, memory 106, video encoder/decoder 107, depth sensor 108, audio encoder/decoder 109, digital signal processor (DSP) 110, input/output module 112, one or more image sensors 114, optics 116, lens 118, a digital display 120, controls 122, and optical viewfinder 124.

The processor 104 may comprise suitable logic, circuitry, interfaces, and/or code. The processor 104 may be operable to coordinate operation of the various components of the monoscopic camera 102. The processor 104 may, for example, run an operating system of the monoscopic camera 102 and control communication of information and signals between components of the monoscopic camera 102. The processor 104 may execute instructions stored in the memory 106.

The memory 106 may comprise, for example, DRAM, SRAM, flash memory, a hard drive or other magnetic storage, or any other suitable memory devices. For example, SRAM may be utilized to store data utilized and/or generated by the processor 104 and a hard-drive and/or flash memory may be utilized to store recorded image data and depth data.

The video encoder/decoder 107 may comprise suitable logic, circuitry, interfaces, and/or code. The video encoder/decoder 107 may be operable to process captured color, brightness, and/or depth data to make the data suitable for conveyance to, for example, the display 120 and/or to one or more external devices via the I/O block 114. For example, the video encoder/decoder 107 may convert between, for example, raw RGB or YcrCb pixel values and an MPEG encoding. Although depicted as a separate block 107, the video encoder/decoder 107 may be implemented in the DSP 110.

The depth sensor 108 may comprise suitable logic, circuitry, interfaces, and/or code. The depth sensor 108 may be operable to detect EM waves in the infrared spectrum and determine distance to objects based on reflected infrared waves. In an embodiment of the invention, distance may be determined based on time-of-flight of infrared waves transmitted by the emitter 109 and reflected back to the sensor 108. In an embodiment of the invention, depth may be determined based on distortion of a captured grid.

The audio encoder/decoder 109 may comprise suitable logic, circuitry, interfaces, and/or code. The audio encoder/decoder 109 may be operable to process captured audio data to make the data suitable for conveyance to, for example, the speaker 111 and/or to one or more external devices via the I/O block 114. For example, the video encoder/decoder 107 may convert between, for example, raw pulse-code-modulated audio and an MP3 or AAC encoding. Although depicted as a separate block 109, the audio encoder/decoder 109 may be implemented in the DSP 110.

The digital signal processor (DSP) 110 may comprise suitable logic, circuitry, interfaces, and/or code. The DSP 110 may be operable to perform complex processing of captured image data, captured depth data, and captured audio data. The DSP 110 may be operable to, for example, compress and/or decompress the data, encode and/or decode the data, and/or filter the data to remove noise and/or otherwise improve perceived audio and/or video quality for a listener and/or viewer.

The input/output module 112 may comprise suitable logic, circuitry, interfaces, and/or code that may enable the monoscopic camera 102 to interface with other devices in accordance with one or more standards such as USB, PCI-X, IEEE 1394, HDMI, DisplayPort, and/or analog audio and/or analog video standards. For example, the I/O module 112 may be operable to send and receive signals from the controls 122, output video to the display 120, output audio to a speaker 111, handle audio input from the microphone 113, read from and write to cassettes, flash cards, or other external memory attached to the monoscopic camera 102, and/or output audio and/or video via one or more ports such as a IEEE 1394 or USB port.

The microphone 113 may comprise a transducer and associated logic, circuitry, interfaces, and/or code operable to convert acoustic waves into electrical signals. The microphone 113 may be operable to amplify, equalize, and/or otherwise process captured audio signals. The directionality of the microphone 113 may be controlled electronically and/or mechanically. The monoscopic camera 102 may also be operable to receive audio signals from one or more remotely located microphones.

The image sensor(s) 114 may each comprise suitable logic, circuitry, interfaces, and/or code that may be operable to convert optical signals to electrical signals. Each image sensor 114 may comprise, for example, a charge coupled device (CCD) images sensor or a complimentary metal oxide semiconductor (CMOS) image sensor. Each image sensor 114 may capture 2D brightness and/or color information.

The error protection module 315 may comprise suitable logic, circuitry, interfaces and/or code that may be operable to perform error protection functions for the video monoscopic camera 300. For example, the error protection module 315 may provide error protection to encoded 2D video images and corresponding depth information and/or encoded audio data for transmission to a 3-D video rendering device such as the 3-D video rendering device 204. The error protection module 315 may apply one or more levels of error protections to an encoded 2D video image frame and/or corresponding depth information or data based on one or more of interest within the encoded 2D video image frame.

The optics 116 may comprise various optical devices for conditioning and directing EM waves received via the lens 101c. The optics 116 may direct EM waves in the visible spectrum to the image sensor 114 and direct EM waves in the infrared spectrum to the depth sensor 108. The optics 116 may comprise, for example, one or more lenses, prisms, color filters, and/or mirrors.

The lens 118 may be operable to collect and sufficiently focus electromagnetic waves in the visible and infrared spectra.

The digital display 120 may comprise an LCD, LED, OLED, or other digital display technology on which images recorded via the monoscopic camera 102 may be displayed. In an embodiment of the invention, the digital display 120 may be operable to display 3-D images.

The controls 122 may comprise suitable logic, circuitry, interfaces, and/or code. The controls 122 may enable a user to interact with the monoscopic camera 102. For example, controls for controlling recording and playback. In an embodiment of the invention, the controls 122 may enable a user to select whether the monoscopic camera 102 records and/or outputs video in 2D or 3-D modes.

The optical viewfinder 124 may enable a user to see what the lens 101c “sees,” that is, what is “in frame.”

In operation, the image sensor(s) 114 may capture frames of 2D video. The depth sensor 108 may capture depth information associated with the objects appearing in the video frames. An audio track to accompany the video may be processed and/or generated based on the pixel data of the video and/or based on the captured depth information. In this regard, characteristics of the audio, such as volume, frequency, delay, left-right balance, and front-back balance, may be adjusted based on the captured pixel data and/or depth information. The audio track may comprise, for example, audio captured concurrently with the capturing of the video and depth information and/or may comprise sound effects and/or other audio captured and/or generated separately from the video.

In one exemplary scenario, a object which didn't make any sound while being recorded may appear in the video and audio to be perceived by a viewer of the video as emanating from that object may be added during editing of the video. Characteristics of the added audio may be adjusted based on a location and/or movement of the object. The location and/or movement of the object may be determined based on the pixel data and/or captured depth information.

In another exemplary scenario, the video may comprise images of a sound source and the audio from the sound source may be captured concurrently by the microphone 113. Subsequently, during editing of the video, the camera angle or location of the camera may be artificially manipulated such that the perceived location of the sound source relative to the viewer of the video is different than was the location of the sound source relative to the monoscopic camera 102. Accordingly, the audio may be manipulated such that the origin of the audio, as perceived by a viewer of the video, corresponds to the location of the sound source, as perceived by the viewer of the video. In other words, as the video is manipulated, the audio may be manipulated to ensure that the audio tracks its source as the source moves around relative to the viewer.

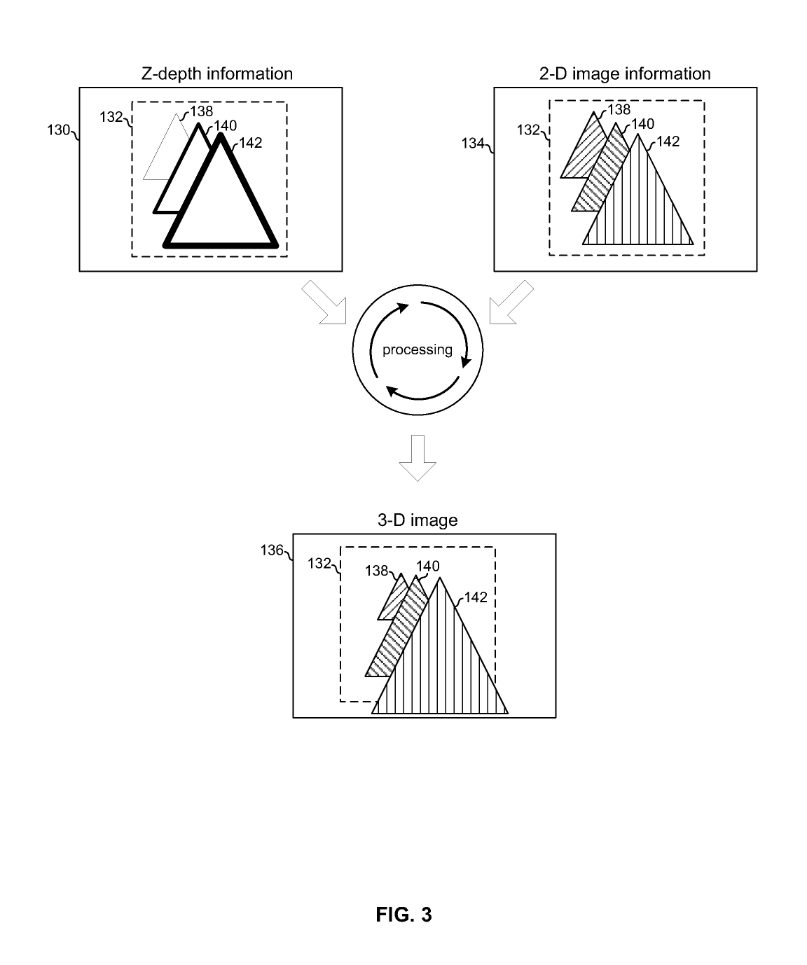

FIG. 3 illustrates processing of depth information and 2D image information to generate a 3-D image, in accordance with an embodiment of the invention. Referring to FIG. 3 the frame of depth information 130, captured by the depth sensor(s) 108, and the frame of 2D image information 134, captured by the image sensors 114, may be processed to generate a frame 136 of a 3-D image. The plane 132, indicated by a dashed line, is merely for illustration purposes to indicate depth on the two dimensional drawing sheets.

In the frame 130, the line weight is used to indicate depth—heavier lines being closer to the viewer. Thus, the object 138 is farthest from the monoscopic camera 102, the object 142 is closest to the monoscopic camera 102 and the object 104 is at an intermediate distance. In various embodiments of the invention, depth information may be mapped to a grayscale, or pseudo-grayscale, image for display to a viewer. Such mapping may be performed, for example, by the DSP 110.

The image in the frame 134 is a conventional 2D image. A viewer of the frame 134, for example, on the display 120 or on a device connected to the monoscopic camera 102 via the I/O module 112, perceives the same distance between himself and each of the objects 138, 140, and 142. That is, each of the objects 138, 140, and 142 each appear to reside on the plane 132.

The image in the frame 136 is a 3-D image. A viewer of the frame 136, for example, on the display 120 or on a device connected to the monoscopic camera 102 via the I/O module 112, perceives the object 138 being furthest from him the object 142 being closest to him, and the object 140 being at an intermediate distance. In this regard, the object 138 appears to be behind the reference plane, the object 140 appears to be on the reference plane, and the object 142 appears to be in front of the reference plane.

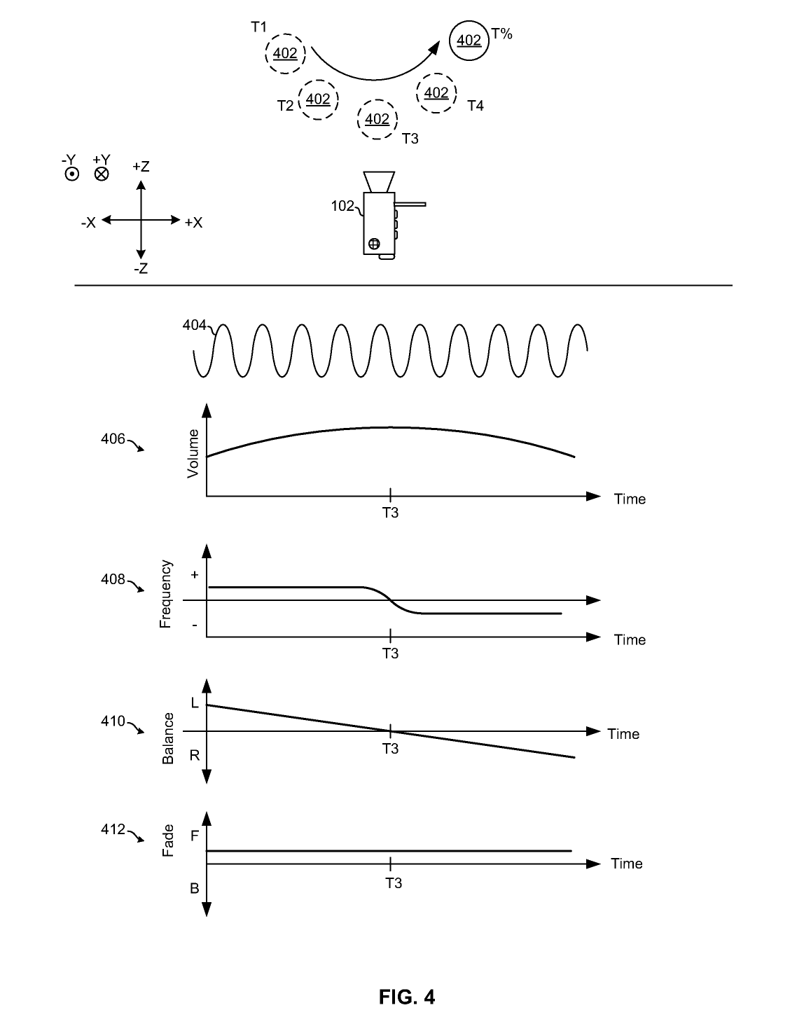

FIG. 4 is a diagram illustrating adjustment of audio characteristics based on a location of a sound source in a scene, in accordance with an embodiment of the invention. Referring to FIG. 4 from time instant T1 to time instant T5, the monoscopic camera 102 may record video, via image sensor(s) 114, and depth data, via depth sensor(s) 108, of an object 402 moving toward and then away from the monoscopic camera 102. Also depicted in FIG. 4, is an audio signal 404 to be manipulated during post processing such that a viewer of the video perceives the audio signal 404 as emanating from the object 402. For illustration, the audio signal 404 is a sinusoid, but the invention is not so limited. Graphs 406, 408, 410, and 412 illustrate exemplary control of various audio characteristics based on the location and movement of the object 402. The location and movement of the object 402 may be determined based on the pixel data of the video frames depicting the object 402 and/or based on the captured depth data associated with such video frames. The location in a stereo or surround-sound environment, the audio signal 404 may be output on a plurality of audio channels. For purposes of illustration, four channels—front left (FL), front right (FR) 404, back left (BL), and back right (BR)—will be used. However, the invention is not so limited.

Location of the object may be described utilizing the three-dimensional coordinate system depicted in FIG. 4. In this regard, the monoscopic camera, and thus the viewer, may reside at the origin and the positive x axis may be to the right of the camera/viewer, the negative x axis may be to the left, the positive y axis may be up (i.e., out of the drawing sheet), the negative y axis may be down (i.e., into the drawing sheet), the positive z direction may be in front of the camera/viewer, and the negative z axis may be behind the camera/viewer.

The graph 406 illustrates control of the overall volume. As the object 402 moves closer to the monoscopic camera 102, and thus the viewer, the overall volume, that is the combined volume of the four audio channels, may be increased.

The graph 408 illustrates control of audio frequency. Audio frequency may be adjusted to simulate a Doppler effect. Thus, as the object 402 is moving toward the monoscopic camera 102, and thus the viewer, the frequency of the signal 404 may be increased and as the object 402 is moving away from the monoscopic camera, and thus the viewer, the frequency may be decreased.

The graph 410 illustrates control of left-right balance. As the object 402 moves from the viewer' left to the viewer's right, the volume of the FL and BL channels may be reduced and the volume of the FR and BR channels may be increased.

The graph 412 illustrates control of the front-back fading. Since the object appears in front of the viewer, the volume of the FL and FR channels may be higher than the volume of the BL and BR channels. However, simulated echo or other ancillary sounds may be added onto the BL and BR channels to provide a more realistic audio experience.

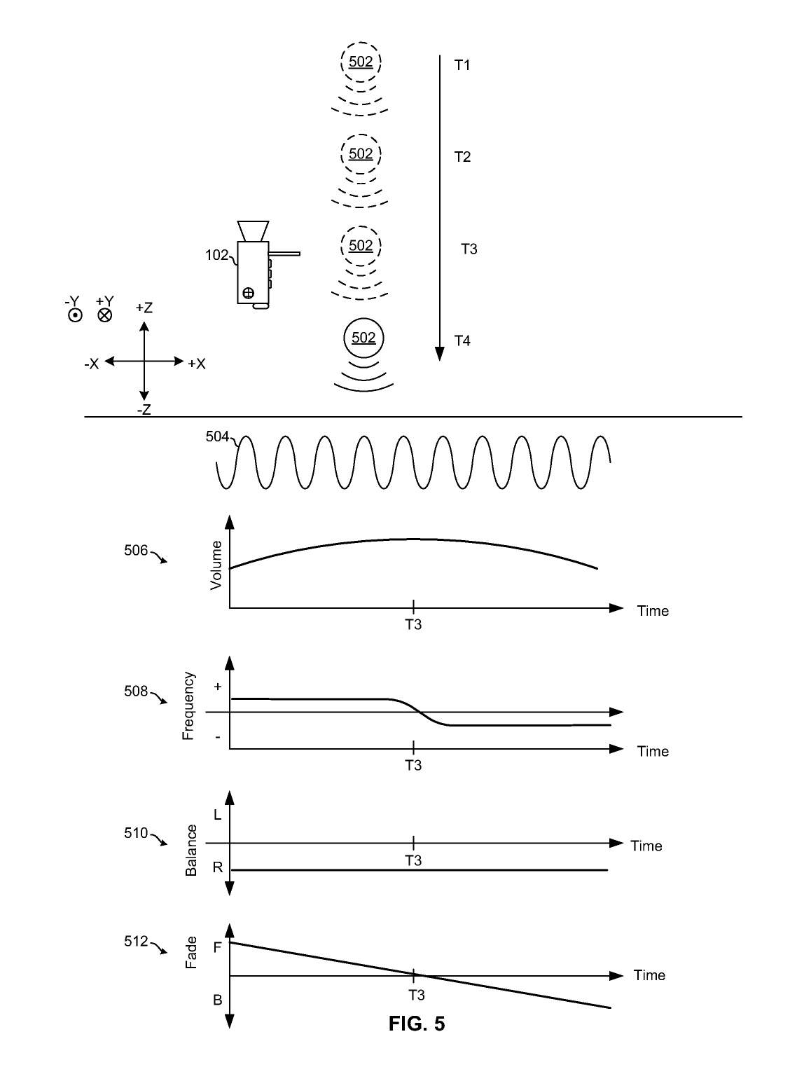

FIG. 5 is a diagram illustrating adjustment of audio characteristics based on a location of a sound source in a scene, in accordance with an embodiment of the invention. Referring to FIG. 5 from time instant T1 to time instant T4, the monoscopic camera 102 may record video, via image sensor(s) 114, and depth data, via depth sensor(s) 108, of an object 502 moving past the monoscopic camera 102. Also depicted in FIG. 5, is an audio signal 504 to be manipulated during post processing such that a viewer of the video perceives the audio signal 504 as emanating from the object 502. For illustration, the audio signal 404 is a sinusoid, but the invention is not so limited. Each of the graphs 506, 508, 510, and 512 illustrates exemplary control of various audio characteristics based on the location and movement of the object 502. The location and movement of the object 502 may be determined based on the pixel data of the video frames depicting the object 502 and/or based on the captured depth data associated with such video frames. In a stereo or surround-sound environment, the audio signal 504 may be output on a plurality of audio channels. For illustration, four channels—front left (FL), front right (FR) 404, back left (BL), and back right (BR)—will be used. However, the invention is not so limited.

A location of the object may be described utilizing the three-dimensional coordinate system depicted in FIG. 4. In this regard, the monoscopic camera 102, and thus the viewer, may reside at the origin and the positive x axis may be to the right of the camera/viewer, the negative x axis may be to the left, the positive y axis may be up (i.e., out of the drawing sheet), the negative y axis may be down (i.e., into the drawing sheet), the positive z direction may be in front of the camera/viewer, and the negative z axis may be behind the camera/viewer.

The graph 506 illustrates control of the overall volume. As the object 502 moves closer to the monoscopic camera 102, and thus the viewer, the overall volume, that is the combined volume of the four audio channels, may be increased. As the object 502 moves away from the viewer the overall volume may be decreased.

The graph 508 illustrates control of audio frequency. Audio frequency may be adjusted to simulate a Doppler effect. Thus, as the object 502 is moving toward the monoscopic camera 102, and thus the viewer, the frequency of the signal 504 may be increased and as the object 502 is moving away from the monoscopic camera 102, and thus the viewer, the frequency may be decreased.

The graph 510 illustrates control of left-right balance. Because the object appears to the right of the viewer, the volume of the FR and BR channels may be higher than the volume of the FL and BL channels. However, simulated echo or other ancillary sounds may be added onto the FL and FR channels to provide a more realistic audio experience.

The graph 512 illustrates control of the front-back fading. As the object 402 moves from in front of the viewer to behind the viewer, the volume of the FL and FR channels may be reduced and the volume of the BL and BR channels may be increased.

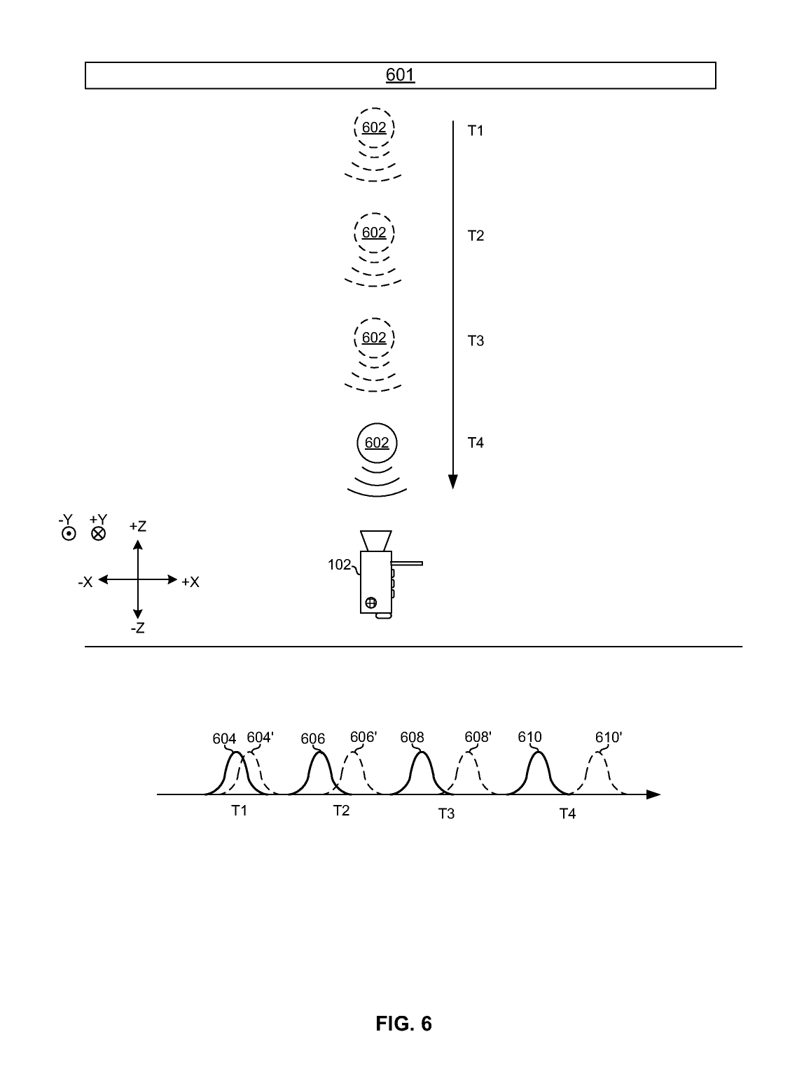

FIG. 6 is a diagram illustrating adjustment of audio timing based on a location of a sound source in a scene, in accordance with an embodiment of the invention. Referring to FIG. 6, from time instant T1 to time instant T4, the monoscopic camera 102 may record a video of an object 602 moving away from a reflective surface 601 toward the monoscopic camera 102. The surface 601 may be computer generated and may be added to the video during post production. Also shown are audio signals 604-610 and 604′-610′. The audio signals 604-610 may have been captured, via the microphone 113, concurrently with the recording of the video. The audio signals 804′-810′ may comprise, for example, simulated or synthetic audio added during post processing. In this regard, the signals 804′-810′ may be, respectively, simulated echoes corresponding to the signals 804-810 reflecting off the surface 801. The time between the signal 6xx and its echo 6xx′ may be determined by the distance between the source 602 and the simulated surface 601. That is, the delay of the simulated audio 6xx′ relative to the actual audio 6xx may be controlled based on the determined distance. This distance may be determined based on the pixel data of the video frames and/or based on the captured depth data associated with such video frames.

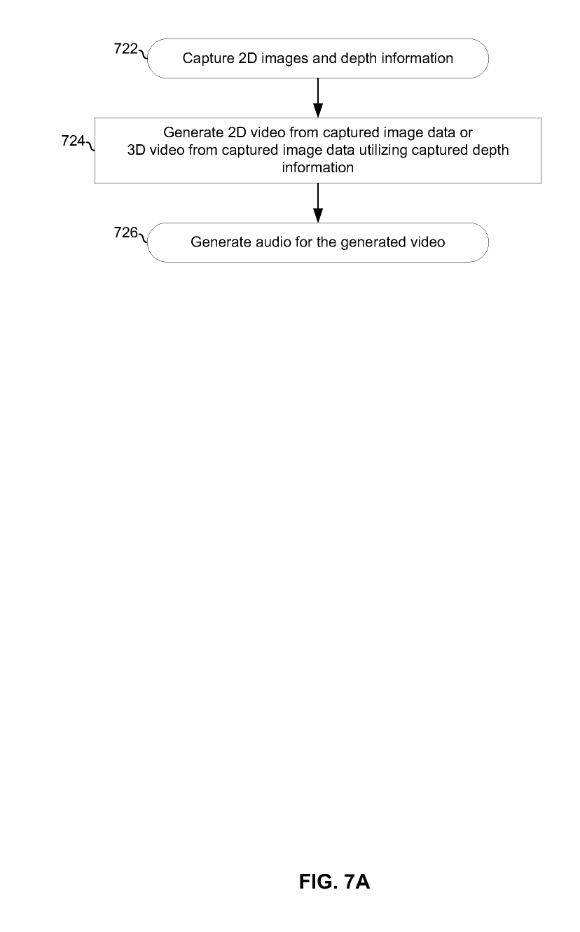

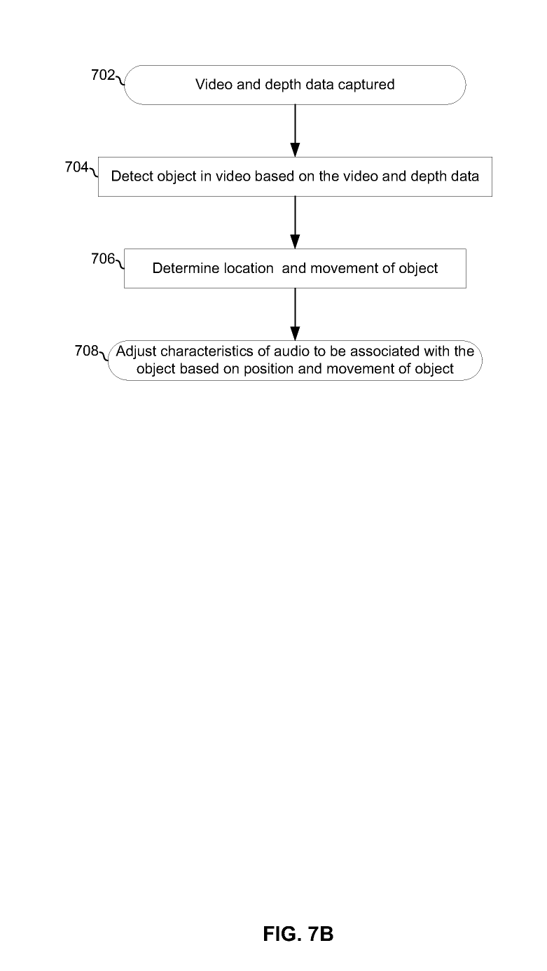

FIG. 7A is a diagram illustrating exemplary steps for generating corresponding audio for a video generated by a monoscopic camera that captures two-dimensional image data via one or more image sensors and captures depth information via a depth sensor, in accordance with an embodiment of the invention. The exemplary steps may begin with step 722 in which the monoscopic camera 102 may capture 2D image data via the images sensor(s) 114 and capture corresponding depth information via the depth sensor(s) 108. In step 724, the monoscopic camera 102 may generate a video stream. The monoscopic camera 102 may generate a 2D video stream utilizing the captured image information. Additionally or alternatively, the monoscopic camera 102 may utilize the captured depth information to generate a 3-D video stream from the captured 2D image data. The generated video stream may be output to the display 120 and/or to an external device via the I/O module 112. In step 726, the monoscopic camera 102 may generate an audio stream to accompany the generated video stream. In this regard, characteristics of the audio stream may be determined based on the captured depth information. The audio stream may, for example, may be output to the speaker(s) 111 and/or to an external device via the I/O module 112. The audio stream may be combined or communicated along with the video stream resulting in a multimedia stream. The multimedia stream may be communicated to an external device via the I/O module 112.

FIG. 7B is a flowchart illustrating exemplary steps for adjusting audio associated with 3-D video based on distances and/or movement detected utilizing captured pixel data and/or captured depth data, in accordance with an embodiment of the invention. In step 702, video and depth information may be captured by a monoscopic camera 102. In step 704, one or more objects in the video may be detected based on the captured pixel data and the captured depth data. In step 706, the location of the object and/or movement of the object may be determined based on the pixel data and/or the captured depth information. In step 708, an audio signal intended to be perceived by a viewer of the video as emanating from the object may be added during post processing. Accordingly, characteristics of the audio signal may be adjusted based on the location and/or movement of the object such that a viewer of the video may perceive the audio as emanating from the object.

Various aspects of a method and system for adjusting audio based on captured depth information are provided. In an exemplary embodiment of the invention, characteristics of one or more audio signals associated with a video, such as signals 404 and 504, may be adjusted based on pixel data of the video and based on depth information captured while recording the video. The video may be captured via one or more image sensors 114 of a monoscopic camera 102 and the depth information may be captured via one or more depth sensors 108 of the monoscopic camera 102. The depth sensor(s) 108 may utilize infrared waves transmitted by an emitter 109 integrated into the monoscopic camera 102. The captured depth information may be stored in memory separately from the pixel data of the captured video. The captured video may comprise two-dimensional video. The monoscopic camera 102 may be operable to process frames of two-dimensional video, such as the frame 130, utilizing frames of captured depth information, such as the frame 134, to generate frames of a three-dimensional video, such as frame 136. The depth information may be utilized to determine a location and/or movement of an object appearing in the video, such as objects 402 and 502. The location of the object may be stored as one or more three-dimensional coordinates. A volume, frequency, delay, and/or balance of the one or more audio signals may be adjusted based on the determined location and/or movement.

In various embodiments of the invention, two-dimensional image may be captured via the image sensor(s) 114 of the monoscopic camera 102, depth information may be captured via the depth sensor(s) 108 of the monoscopic camera 102, a video stream may generated from the captured two-dimensional image data based on the captured depth information, and corresponding audio may be generated based on the captured depth information. The generated video stream may be a 3-D video stream. The generated audio and video may be combined to generate a multimedia stream. The generated corresponding audio may be adjusted based on the captured depth information.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for generating three-dimensional video utilizing a monoscopic camera.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
capturing two-dimensional image data via one or more image sensors of a monoscopic camera;
capturing depth information via a depth sensor of said monoscopic camera; and
generating corresponding audio for a video stream generated from said captured two-dimensional image data based on said captured depth information.

2. The method according to claim 1, comprising generating a three-dimensional video stream from said captured two-dimensional image data utilizing said captured depth information.

3. The method according to claim 2, comprising adjusting said corresponding audio for generated three-dimensional video stream based one said captured depth information.

4. The method according to claim 1, comprising generating a multimedia stream utilizing said captured two-dimensional image data, said captured depth information and said generated corresponding audio.

5. The method according to claim 1, comprising determining a location and/or movement of an object appearing in said captured two-dimensional image data based on said depth information and based on pixel data of said captured two-dimensional image data.

6. The method according to claim 5, comprising adjusting a volume of said generated corresponding audio based on said determined location and/or movement.

7. The method according to claim 5, comprising adjusting a frequency of said generated corresponding audio based on said determined location and/or movement.

8. The method according to claim 5, comprising adjusting a delay of said generated corresponding audio based on said determined location and/or movement.

9. The method according to claim 5, comprising adjusting a left-right balance and/or front-back balance of said generated corresponding audio based on said determined location and/or movement.

10. The method according to claim 1, wherein said depth sensor utilizes infrared waves transmitted by an emitter of said camera.

11. A system comprising:
one or more circuits for use in a monoscopic camera, said one or more circuits being operable to:
capture two-dimensional image data via one or more image sensors of a monoscopic camera;
capture depth information via a depth sensor of said monoscopic camera; and
generate corresponding audio for video generated from said captured two-dimensional image data based on said captured depth information.

12. The system according to claim 11, wherein said one or more circuits are operable to generate a three-dimensional video stream from said captured two-dimensional image data utilizing said captured depth information.

13. The system according to claim 12, wherein said one or more circuits are operable to adjust said corresponding audio for generated three-dimensional video stream based one said captured depth information.

14. The system according to claim 11, wherein said one or more circuits are operable to generate a multimedia stream utilizing said captured two-dimensional image data, said captured depth information and said generated corresponding audio.

15. The system according to claim 11, wherein said one or more circuits are operable to determine a location and/or movement of an object appearing in said captured two-dimensional image data based on said depth information and based on pixel data of said captured two-dimensional image data.

16. The system according to claim 15, wherein said one or more circuits are operable to adjust a volume of said generated corresponding audio based on said determined location and/or movement.

17. The system according to claim 15, wherein said one or more circuits are operable to adjust a frequency of said generated corresponding audio based on said determined location and/or movement.

18. The system according to claim 15, wherein said one or more circuits are operable to adjust a delay of said generated corresponding audio based on said determined location and/or movement.

19. The system according to claim 15, wherein said one or more circuits are operable to adjust a left-right balance and/or front-back balance of said generated corresponding audio based on said determined location and/or movement.

20. The system according to claim 11, wherein said depth sensor utilizes infrared waves transmitted by an emitter of said camera.
